(19) United States
(12) Patent Application Publication
(10) Pub. No.: US 2021/0200550 A1
(43) Pub. Date: Jul. 1, 2021

(54) LOOP EXIT PREDICTOR

(71) Applicant: Intel Corporation, Santa Clara, CA (US)

(72) Inventors: Alexey Yurievich SIVTSOV, Moscow (RU); Franck SALA, Haifa (IL); Jared Warner STARK, IV, Portland, OR (US); Lihu RAPPOPORT, Haifa (IL)

(21) Appl. No.: 16/729,367

(22) Filed: Dec. 28, 2019

(51) Int. Cl. G06F 9/38; G06F 9/30

(52) U.S. Cl. CPC G06F 9/3806; G06F 9/30065; G06F 9/30145

(57) ABSTRACT

Disclosed embodiments relate to systems and methods structured to predict a loop exit. In one example, a processor includes a branch prediction unit to determine a loop exit predictor start corresponding to a finite consistent loop, and an instruction decoder queue to: receive an iteration of the finite consistent loop corresponding to a loop exit predictor and an iteration count, replay one or more instructions of the iteration based on the iteration count, and switch to post-loop instructions responsive to a determination that a number of iterations of the finite consistent loop is equal to the iteration count.

### FIELD OF INVENTION

The field of invention relates generally to computer processor architecture, and, more specifically, to systems and methods for predicting a loop exit.

### BACKGROUND

Micro-processors generally contain a loop stream detector (LSD) to reduce power consumption. The loop stream detector detects when a loop with an infinite iteration count was executed in software. When the loop stream detector is active the processor front end is powered down in addition to the fetch hardware.

Some techniques for preserving the power required for fetching and decoding instructions are based on loop stream detector software for processors with binary translation support. However, such software loop stream detectors are applicable only to large body loops and processors with binary translation support and are static predictors that cannot change the iteration count based on dynamic execution, thereby, limiting the front end capabilities.

Efficiently predicting a loop exit may assist in meeting the needs of processors, for example, performing workloads with infinite and finite body loops or other demands requiring increased front end power.

### BRIEF DESCRIPTION OF THE DRAWINGS

The present invention is illustrated by way of example and are not limitations in the figures of the accompanying drawings, in which like references indicate similar elements and in which:

FIG. 1 illustrates a block diagram of a loop exit prediction system according to one embodiment of the invention;

FIG. 2 illustrates examples of embodiments of a method of predicting a loop exit corresponding to a finite consistent loop as detailed herein;

FIG. 3 illustrates an example of a finite consistent loop as detailed herein;

FIG. 4 illustrates examples of embodiments of a method of predicting a loop exit corresponding to a non-finite consistent loop as detailed herein;

FIG. 5 illustrates an example of a non-finite consistent loop as detailed herein;

FIG. 6 is a block diagram of a register architecture according to one embodiment of the invention;

FIG. 7A is a block diagram illustrating both an exemplary in-order pipeline and an exemplary register renaming, out-of-order issue/execution pipeline according to embodiments of the invention;

FIG. 7B is a block diagram illustrating both an exemplary embodiment of an in-order architecture core and an exemplary register renaming, out-of-order issue/execution architecture core to be included in a processor according to embodiments of the invention;

FIGS. 8A-B illustrate a block diagram of a more specific exemplary in-order core architecture, which core would be one of several logic blocks (including other cores of the same type and/or different types) in a chip;

FIG. 9 is a block diagram of a processor 1700 that may have more than one core, may have an integrated memory controller, and may have integrated graphics according to embodiments of the invention;

FIGS. 10-13 are block diagrams of exemplary computer architectures; and

FIG. 14 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The loop exit predictor (LEP) system is a front end system that predicts the exit from a loop corresponding to a finite consistent loop (FCL) and/or a non-finite consistent loop (non-FCL). As used herein, the term “finite consistent loop” may be used to refer to a loop associated with an iteration count less than infinity. In some embodiments, a finite consistent loop may have the same iteration count for every loop execution. The term “non-finite consistent loop” may be used to refer to a loop associated with an infinite iteration count as described herein.

The loop exit prediction system mitigates bottlenecks that result from the loop stream detector (LSD). The loop exit prediction system predicts the iteration count of a finite consistent loop. The loop exit prediction system replays an iteration of the finite consistent loop from the instruction decoder unit.

For example, the loop exit prediction system may start with determining a loop exit predictor start corresponding to a finite consistent loop and receiving an iteration of the finite consistent loop corresponding to a loop exit predictor and an iteration count. One or more instructions of the iteration are replayed based on the iteration count.

Advantageously, the iteration is replayed without a warm-up such that the loop is learned during the first execution of the loop. In some embodiments, the loop exit prediction system replays the finite consistent loop from the second loop iteration. In this regard, there are not any loop learning cycles that are wasted for such finite consistent loops. The loop exit prediction system switches to the post-loop instructions responsive to a determination that a number of iterations of the finite consistent loop is equal to the iteration count. The loop exit prediction system exits from replaying the finite consistent loop without a prediction event (e.g., an event indicative of an exit from a loop due to a branch misprediction) as described herein.

In examples wherein the loop exit prediction system predicts the exit from a non-finite consistent loop. The loop exit prediction system replays an iteration of the non-finite consistent loop from the instruction decoder unit, and exits from replaying the non-finite consistent loop in response to a prediction event (e.g., in response to a misprediction event such as a Jeclear).

Predicting a loop exit as described herein provides for performance improvements by predicting the loop exit of finite consistent loops and reducing the power required by the frontend. Further embodiments advantageously reduces the loop stream detector misprediction penalty by performing a prediction event (e.g., a jump execution command (Jeclear)) from the instruction decoder unit. Accordingly, the loop exit prediction system reduces the Jeclear penalty that results from a loop stream detector loop. The average gain that results from the loop exit prediction system may be greater than 4% when compared to the results from a loop stream detector. In addition, the loop exit prediction system reduces the execution of a Jeclear by 3%.

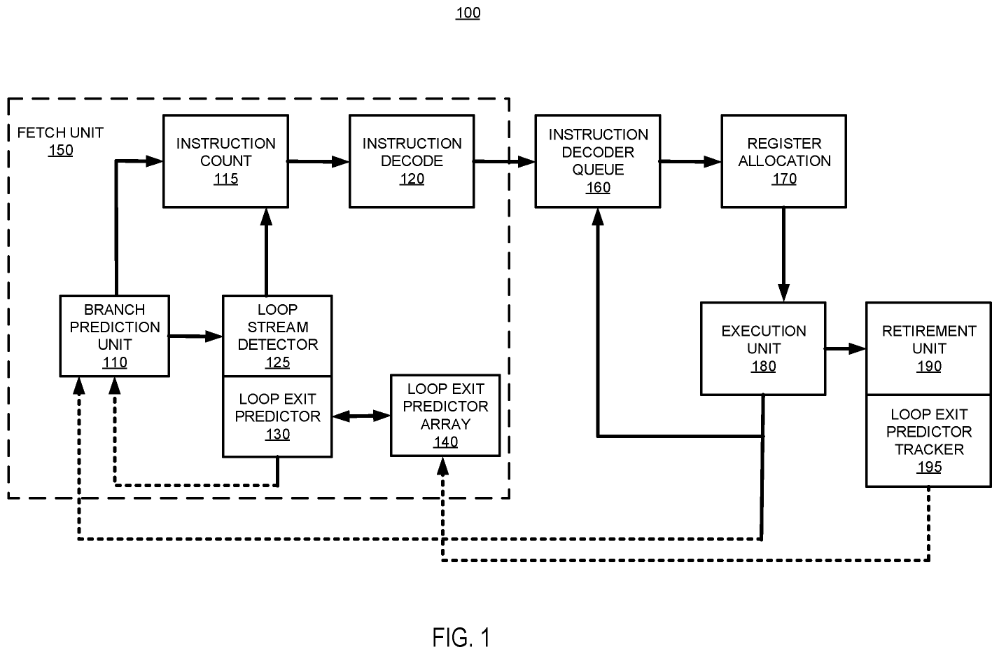

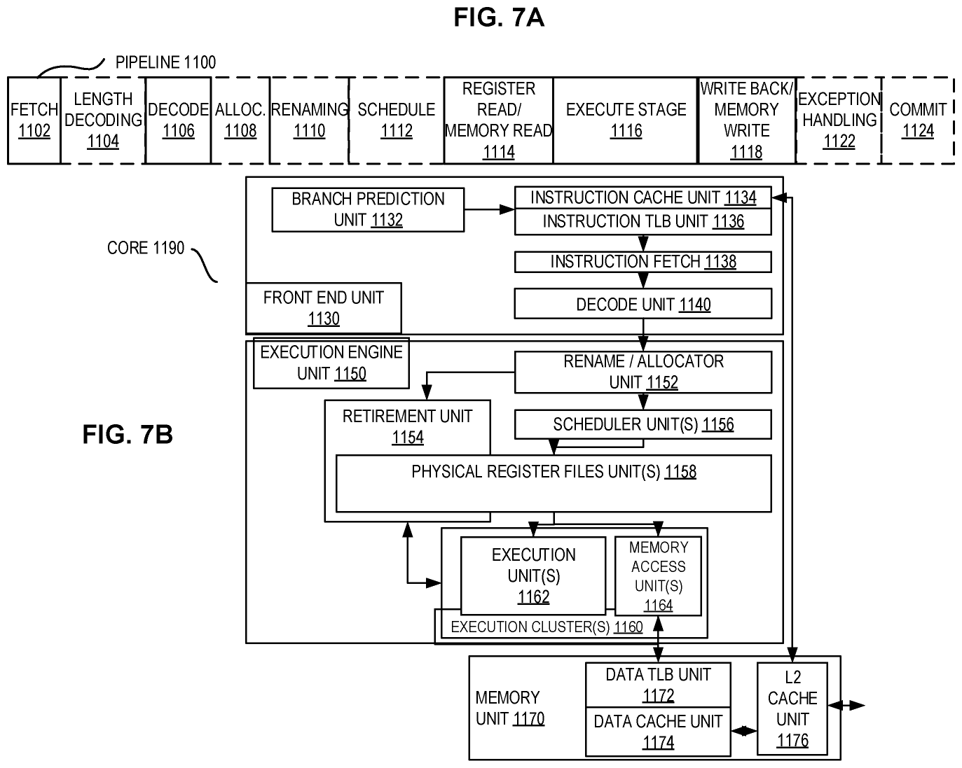

FIG. 1 illustrates a block diagram of a loop exit prediction system 100 (e.g., a system structured to predict a loop exit from a finite consistent loop or a non-finite consistent loop) according to one embodiment of the invention. As shown, the loop exit prediction system 100 includes a fetch unit 150 communicably and operatively coupled to an instruction decoder queue 160, a register allocation 170, an execution unit 180, a retirement unit 190, and a loop exit predictor tracker 195. The fetch unit 150 includes a branch prediction unit 110, an instruction count 115, an instruction decode 125, a loop stream detector 125, a loop exit predictor 130, a loop exit predictor array 140, and one or more additional systems, components, etc. It should be understood that the loop exit prediction system 100 may include additional, less, and/or different components/systems than depicted in FIG. 1 and FIGS. 7A, B (e.g., the components/systems such as, but not limited to, the fetch 1102, length decoding 1104, decode 1106, alloc 1108, branch prediction unit 1132, instruction TLB unit 1136, instruction fetch 1138, decode unit 1140, and execution engine unit 1150), such that the principles, methods, systems, processes, and the like of the present disclosure are intended to be applicable with any other loop exit prediction system configuration. It should also be understood that the principles of the present disclosure contemplates that the principles may also be applied to a variety of other applications.

As shown, the loop exit prediction system 100 includes the branch prediction unit 110. The branch prediction unit 110 predicts which branch to feed into the pipeline before the branch to be used is certain or otherwise known. In some embodiments, the branch prediction unit 110 may record whether branches are taken or not taken. If the wrong branch is executed, a branch misprediction occurs and the other branch is fed into the pipeline.

The branch prediction unit 110 may be located at the start of the front end unit (e.g., the pipeline 1100 as depicted in FIG. 7A, B) of the loop exit prediction system 100. Alternatively or additionally, the branch prediction unit 110 may be implemented at any point in the loop exit prediction system 100 such that the position of the branch prediction unit 110 is only exemplary.

The branch prediction unit 110 may include a loop exit predictor (e.g., the loop exit predictor 130). In some embodiments, the loop exit predictor 130 may be coupled to the branch prediction unit 110 directly or indirectly via one or more other (e.g., additional, less, and/or different) components/systems than depicted in FIG. 1. The loop exit predictor 130 learns a loop (e.g., a finite consistent loop) at retirement. After learning the loop, the loop exit predictor 130 may cause the branch prediction unit 110 to provide an iteration of the loop (e.g., the loop body) to an instruction decoder queue 160 during a subsequent execution of the loop (e.g., during the next execution of the loop). In addition, the loop exit predictor 130 may provide an iteration count for the loop to the instruction decoder queue 160. The iteration count may change based on factors such as dynamic execution, global branch history, etc.

The instruction decoder queue 160 manages the replay of a loop (e.g., a finite consistent loop, a non-finite consistent loop, etc.). Accordingly, the instruction decoder queue 160 receives an iteration of the loop and an iteration count associated with the loop. In some embodiments, the instruction decoder queue 160 may receive the loop exit predictor start (e.g., an instruction, a LEP start address, or a combination thereof) and the loop exit predictor end (e.g., an instruction, a LEP end address, or a combination thereof).

When an instruction marked by the loop exit predictor start bit is written into the instruction decoder queue 160, the instruction decoder write pointer may be recorded into the loop stream detector start read pointer and the loop stream detector start signal may be asserted. Although the instruction decoder read entries are not freed for loop exit predictor loops, the instruction decoder unit does not fill to capacity since the loop exit predictor loops are filtered at retirement according to the instruction decoder size.

When an instruction marked by the loop exit predictor end bit is written into the instruction decoder queue 160, the instruction decoder write pointer is copied into the loop stream detector end read pointer.

The iteration counter may be set to the value of the iteration count included with the loop exit predictor end instruction. When the instruction decoder read pointer is equal to the loop stream detector end read pointer, the loop stream detector replay indication is asserted. In turn, the loop stream detector start read pointer may be recorded into the next instruction decoder unit read pointer.

The instruction decoder queue 160 replays the predicted iteration count of the finite consistent loop. In further embodiments, the instruction decoder queue 160 may switch to the post-loop instructions without the occurrence of prediction event (e.g., without the occurrence of a Jeclear) at the loop exit point. In embodiments wherein the loop is a non-finite consistent loop, the instruction decoder queue 160 replays the non-finite consistent loop until a prediction event occurs (e.g., until a Jeclear).

The loop stream detector 125 detects loops that include a large iteration count. The loops are replayed from the instruction decoder unit 160. In some embodiments, the loop stream detector 160 may include a loop stream detector tracker. The loop stream detector tracker may be structured to work with the loop exit predictor 130 to identify a loop exit predictor loop (e.g., a non-finite consistent loop) by matching an instruction pointer (IP) that is fetched by the loop exit predictor array 140. The loop stream detector tracker may mark a fetch line with a loop exit predictor start, a loop exit predictor end, and/or an iteration count.

### LEP for Finite Consistent Loop Method

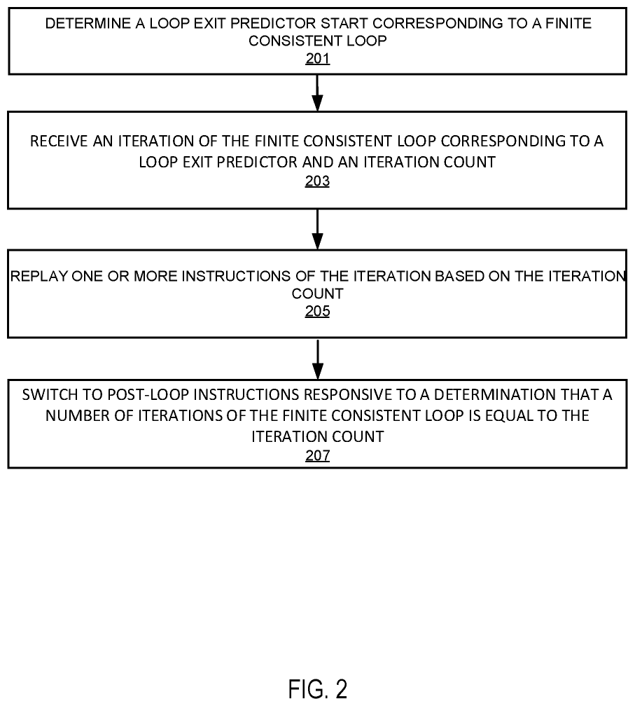

FIG. 2 illustrates examples of embodiments of a method of predicting a loop exit corresponding to a finite consistent loop. The processing of the method is performed by components of a processor or core including, but not limited to, a branch prediction unit, loop exit predictor, and an instruction decoder queue as detailed herein.

At 201, the branch prediction unit is to determine a loop exit predictor start corresponding to a finite consistent loop. For example, the branch prediction unit is to detect the start of the loop exit predictor start. In some embodiments, the branch prediction unit may determine whether a match of a loop exit predictor array entry is confident. If the match of the loop exit predictor array entry is confident, the loop exit predictor enters active mode. The branch prediction unit may then start the prediction of a finite consistent loop. If there is more than one loop exit predictor array entry, the entry associated with a matched STEW (e.g., a representation of the global branch history) signature may be selected. The STEW signature allows the loop exit predictor system to include a plurality of loop exit predictor entries in the array associated with the same finite consistent loop start instruction pointer associated with the same or different STEW.

The instruction decoder queue is to receive an iteration of the finite consistent loop and an iteration count N at 203. The iteration count may change based on dynamic execution, global branch history, or a combination thereof. The received iteration of the loop exit predictor may include a loop exit predictor start (e.g., an instruction, a LEP start address, or a combination thereof) and a loop exit predictor end (e.g., an instruction, a LEP end address, or a combination thereof). The branch prediction unit may reference, via the loop exit predictor, a loop exit predictor array to obtain the loop exit predictor start to ensure that the loop exit predictor detected the first iteration of the loop instead of the loop end.

In active mode, the loop exit predictor may wait for the branch prediction unit taken prediction that matches the loop exit predictor end. The branch prediction unit prediction may be recorded to the loop start address. In some embodiments, the loop exit predictor may provide the iteration count associated with the finite consistent loop to the instruction decoder queue. The loop exit predictor end may be associated with the iteration count. The branch prediction unit may attach the loop exit predictor end and the iteration count N to the fetched line. For example, the loop exit predictor end address may be included with the iteration count for replay of the finite consistent loop. The iteration of the finite consistent loop and the iteration count may be provided by the branch prediction unit or any other suitable component, system, or unit. In some examples, the loop exit predictor end may be marked as loop exit predictable for learning at retirement.

Alternatively or additionally, after the loop exit predictor end is fetched, the branch prediction unit may redirect fetching to preload the post-loop instructions (e.g., the post loop code) into the instruction decoder queue. The loop exit predictor may override the branch prediction unit prediction to “not taken” to fetch the post-loop instructions after the first iteration.

One or more instructions of the iteration are replayed by the instruction decoder queue based on the iteration count at 205. In this regard, the instruction decoder queue is to replay the iteration N times. The iteration counter is decremented each time the loop exit predictor end of the finite consistent loop is sent to the out of order (OOO) core. For example, the iteration counter is decremented each time the loop exit predictor end of the finite consistent loop is sent to the OOO core such as, but not limited to, the register allocation, execution unit, retirement unit, etc.) On the last iteration, when the iteration counter is equal to zero, the instruction decoder queue may set the loop exit predictor end as a “not taken” branch and the loop stream detector replay may stop which prevents the issuance of a misprediction on the last iteration of the loop.

The instruction decoder queue is to switch to the post-loop instructions (e.g., the pre-loaded post-loop instructions) responsive to a determination that a number of iterations of the loop exit predictor is equal to the iteration count at 207. Accordingly when the number of replayed loop exit predictor end instructions is equal to N, the instruction decoder queue may repoint the instruction decoder read pointer to the post-loop instructions. For example, the instruction decoder queue may repoint the instruction decoder read pointer to the next entry after the loop exit predictor end instruction which includes the post-loop code.

### Finite Consistent Loop

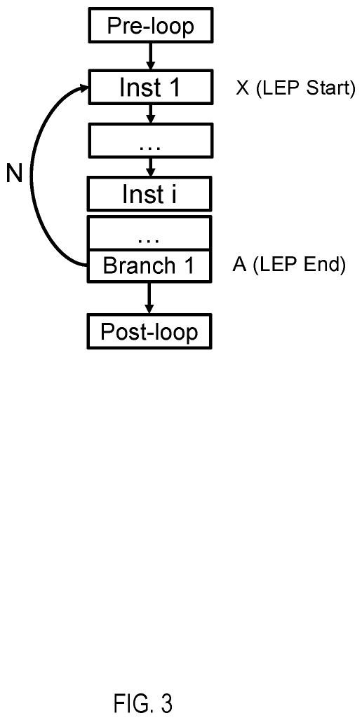

FIG. 3 illustrates an exemplary diagram illustrating a finite consistent loop. The branch prediction unit may identify a taken branch as loop exit predictable. For example, the branch prediction unit identifies the same taken branches A->X in a row as loop exit predictable. If the count of A->X is greater than a minimum finite consistent loop boundary, the branch prediction unit may allocate the loop exit predictor as first in first out (FIFO) to store the branch prediction unit loop information until retirement.

At retirement, the loop exit predictor of the branch prediction unit identifies the loop exit predictor tracker (e.g., a finite consistent loop tracker). The loop exit predictor detects finite consistent loops as consecutive identical conditional backward taken branches (A->X, A->X . . . ). The “A” identifies the loop exit predictor end, while the target of the branch “X” is the loop exit predictor start. The number of taken backward branches (e.g., the number of same taken backward branches) A->X in a row reflects the iteration count N for replay.

In some embodiments, the loop exit predictor tracker determines whether the number of micro-ops (μops) per iteration is consistent and less than the capacity (e.g., size) of the instruction decoder queue. If the loop exit predictor tracker determines that a branch is set to, for example, a not-taken “A” branch which identifies a finite consistent loop exit, the loop exit predictor tracker allocates or otherwise updates the loop exit predictor array with the loop exit predictor start, loop exit predictor end, the iteration count N, and the confidence.

The confidence of the loop exit predictor loop (e.g., a finite consistent loop) may be incremented responsive to the execution of the same iteration count or otherwise decremented. In some embodiments, the loop exit predictor loops may execute a different number of iterations according to the control flow (e.g., according to the global branch history at the beginning of the loop) such that a STEW signature (e.g., a representation of the global branch history) may be added to a loop exit predictor array entry.

### LEP for Non-FCL Method

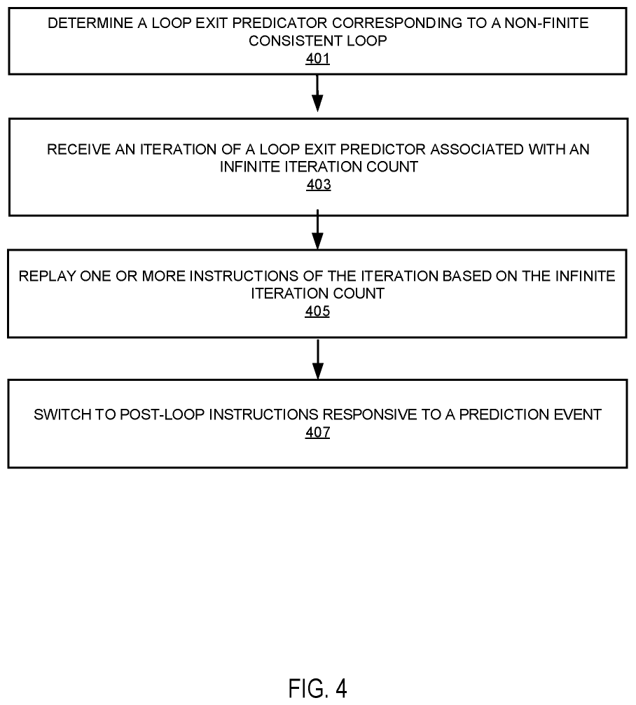

FIG. 4 illustrates examples of embodiments of a method of predicting a loop exit corresponding to a non-finite consistent loop. The processing of the method is performed by components of a processor or core detailed herein with reference to FIG. 2.

At 401, the branch prediction unit is to determine a loop exit predicator start corresponding to a non-finite consistent loop. The branch prediction unit may detect that a loop stream detector loop is a loop exit predictor loop. In this regard, branch prediction unit may determine whether a match of a loop exit predictor entry is confident. If the match of the loop exit predictor entry is confident, the branch prediction unit may start a non-finite loop exit prediction as a loop stream detector loop associated with a reduced warmup.

The instruction decoder queue is to receive an iteration of the loop exit predictor loop associated with an infinite iteration count at 203. The branch prediction unit may provide (e.g., send) the iteration to the instruction decoder queue. In some embodiments, the iteration may include a loop exit predictor start (e.g., an instruction, a LEP start address, or a combination thereof) and a loop exit predictor end (e.g., an instruction, a LEP end address, or a combination thereof). For example, the iteration may be marked to identify a loop exit predictor start, a loop exit predictor end, or a combination thereof. The loop exit predictor end instruction may be included with an infinite iteration count ∞ for replay of the non-finite consistent loop.

The branch prediction unit may redirect fetching to preload the post-loop instructions (e.g., the post loop code) into the instruction decoder queue after the loop exit predictor end is fetched.

One or more instructions of the iteration are replayed by the instruction decoder queue based on the iteration count (e.g., an infinite iteration count) at 205. In this regard, the instruction decoder queue detects the loop exit predictor start and the loop exit predictor end. In turn, the instruction decoder queue infinitely replays the iteration of the loop exit predictor loop (e.g., the non-finite consistent loop).

The instruction decoder queue is to switch to post-loop instructions responsive to a prediction event at 207. In some embodiments, the prediction event includes an event indicative of an exit from a loop due to a branch misprediction such as, but not limited to, a jump execution command (e.g., a Jeclear). In some embodiments, the execution unit may mark a mispredicted branch as Jeclear from the instruction decoder queue. Alternatively or additionally, the instruction decoder queue may repoint the read pointer to the first post-loop instruction. For example, the instruction decoder queue may repoint the read pointer to instruction decoder queue entry after the loop exit predictor end. Advantageously, the loop entries in the instruction decoder queue are removed without the need to clear the fetch unit. In further embodiments, the loop stream detector clears the fetch unit and restarts fetching from the branch prediction unit.

### Non-Finite Consistent Loop

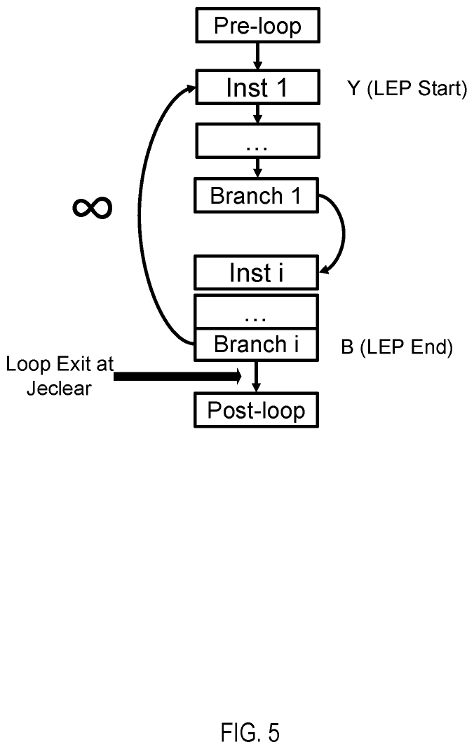

FIG. 5 illustrates an exemplary diagram illustrating a non-finite consistent loop. A non-finite consistent loop is detected at retirement among one or more loop stream detector replayed loops. A branch (e.g., a branch such as Branch 1, Branch i, etc.) may be predicted by the loop exit predictor if the branch is a conditional branch and the branch is identified as “taken”. For such branches, the loop exit predictor array may be allocated. The loop stream detector exit instruction point may be recorded or otherwise store in the loop exit predictor array. In some embodiments, the loop exit predictor start Y may be identified by the target of the loop exit predictable branch and loop exit predictor end B may be identified by the end of the loop exit predictable branch.

Alternatively or additionally, if a subsequent execution of the loop (e.g., during the next execution of the loop) includes or is otherwise identified by the same loop exit point (e.g., a Jeclear from the same branch), the loop may be predicted by the loop exit predictor. The instruction decoder queue replays the non-finite consistent loop infinitely until a prediction event occurs (e.g., until a Jeclear).

### Exemplary Register Architecture

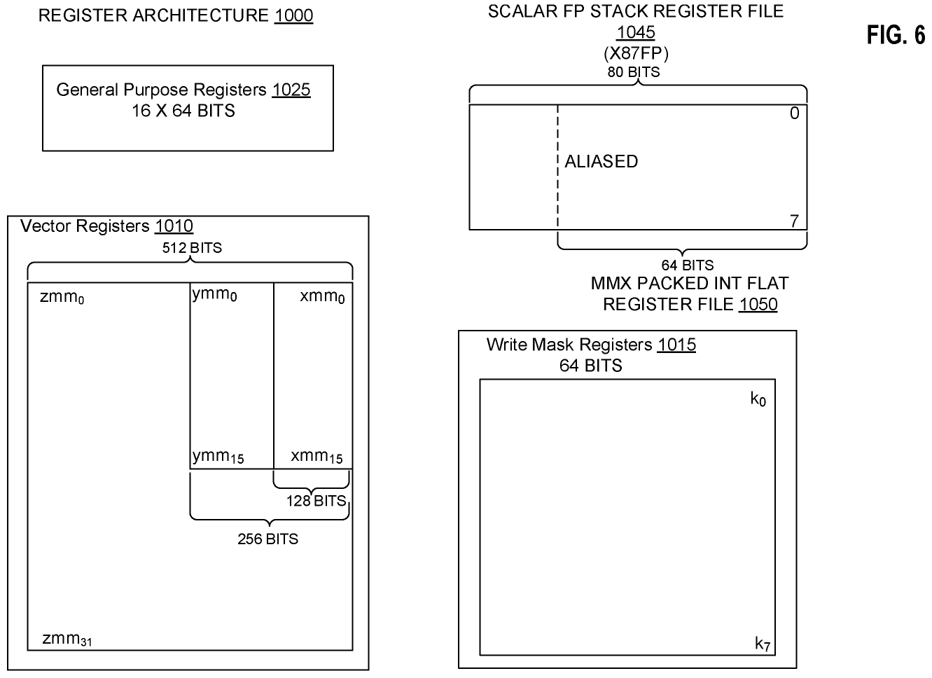

FIG. 6 is a block diagram of a register architecture 1000 according to one embodiment of the invention. In the embodiment illustrated, there are 32 vector registers 1010 that are 58 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 1300 operates on these overlaid register file as illustrated in the below tables.

| Adjustable Vector | | | |
|---|---|---|---|
| Length | Class | Operations | Registers |
| Instruction | A (FIG. | 810, 815, | zmm registers (the vector |
| Templates that do | QABA; | 825, 830 | length is 64 byte) |
| not include the | U = 0) | | |
| vector length | B (FIG. | 88 | zmm registers (the vector |
| field 859B | QABB; | | length is 64 byte) |
| | U = 1) | | |
| Instruction | B (FIG. | 817, 827 | zmm, ymm, or xmm registers |
| templates that do | QABB; | | (the vector length is 64 byte, |
| include the vector | U = 1) | | 32 byte, or 16 byte) depending |
| length field 859B | | | on the vector length field 859B |

In other words, the vector length field 859B selects between a maximum length and one or more other shorter lengths, where each such shorter length is half the length of the preceding length; and instructions templates without the vector length field 859B operate on the maximum vector length. Further, in one embodiment, the class B instruction templates of the specific vector friendly instruction format 1300 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1015—in the embodiment illustrated, there are 8 write mask registers (k0 through k7), each 64 bits in size. In an alternate embodiment, the write mask registers 1015 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 1025—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1045, on which is aliased the MMX packed integer flat register file 1050—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

### In-Order and Out-of-Order Core Block Diagram

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 1100 includes a fetch stage 1102, a length decode stage 1104, a decode stage 1106, an allocation stage 1108, a renaming stage 1110, a scheduling (also known as a dispatch or issue) stage 1512, a register read/memory read stage 1114, an execute stage 1112, a write back/memory write stage 1118, an exception handling stage 1122, and a commit stage 1124.

FIG. 7B shows processor core 1190 including a front end unit 1130 coupled to an execution engine unit 1150, and both are coupled to a memory unit 1130. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In one embodiment, the core 1190 includes a microcode ROM or other medium that stores microcode for certain macroinstructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1120. The execution cluster(s) 1120 includes a set of one or more execution units 1122 and a set of one or more memory access units 1124. The execution units 1122 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1156, physical register file(s) unit(s) 1158, and execution cluster(s) 1120 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1124). It should also be understood that where separate pipelines are used, one or more of these pipelines may be out-of-order issue/execution and the rest in-order.

The set of memory access units 1124 is coupled to the memory unit 1130, which includes a data TLB unit 1136 coupled to a data cache unit 1134 coupled to a level 2 (L2) cache unit 1136. In one exemplary embodiment, the memory access units 1124 may include a load unit, a store address unit, and a store data unit, each of which is coupled to the data TLB unit 1136 in the memory unit 1130. The instruction cache unit 1134 is further coupled to a level 2 (L2) cache unit 1136 in the memory unit 1130. The L2 cache unit 1136 is coupled to one or more other levels of cache and eventually to a main memory.

By way of example, the exemplary register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1512; 5) the physical register file(s) unit(s) 1158 and the memory unit 1130 perform the register read/memory read stage 1114; the execution cluster 1120 perform the execute stage 1112; 6) the memory unit 1130 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1134/1134 and a shared L2 cache unit 1136, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

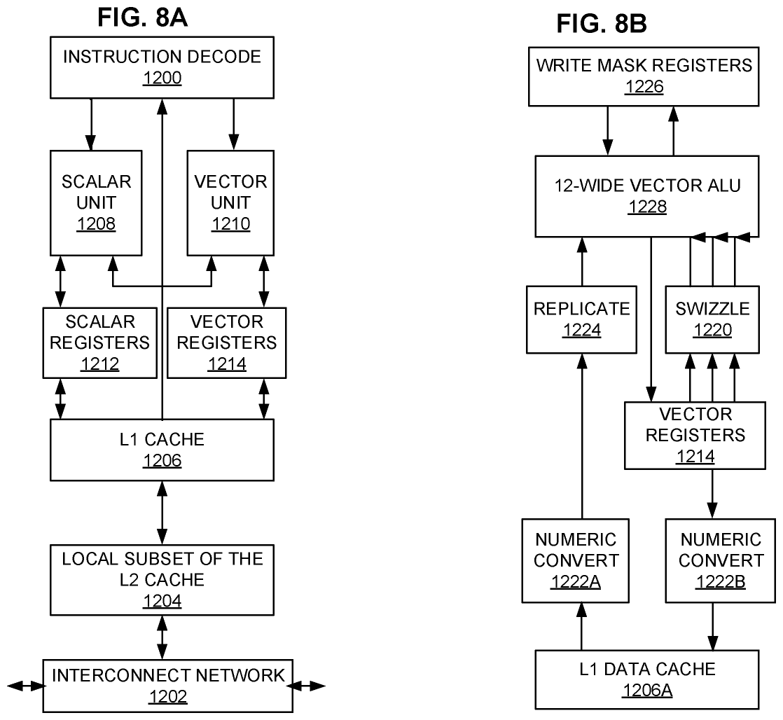

FIGS. 8A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 8A is a block diagram of a single processor core, along with its connection to the on-die interconnect network 1202 and with its local subset of the Level 2 (L2) cache 1204, according to embodiments of the invention. In one embodiment, an instruction decoder 1200 supports the x86 instruction set with a packed data instruction set extension. An L1 cache 1206 allows low-latency accesses to cache memory into the scalar and vector units. While in one embodiment (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative embodiments of the invention may use a different approach (e.g., use a single register set or include a communication path that allow data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 8B is an expanded view of part of the processor core in FIG. 8A according to embodiments of the invention. FIG. 8B includes an L1 data cache 1206A part of the L1 cache 1204, as well as more detail regarding the vector unit 1210 and the vector registers 1214. Specifically, the vector unit 1210 is a 12-wide vector processing unit (VPU) (see the 12-wide ALU 1228), which executes one or more of integer, single-precision float, and double-precision float instructions. The VPU supports swizzling the register inputs with swizzle unit 1220, numeric conversion with numeric convert units 1222A-B, and replication with replication unit 1224 on the memory input. Write mask registers 1226 allow predicating resulting vector writes.

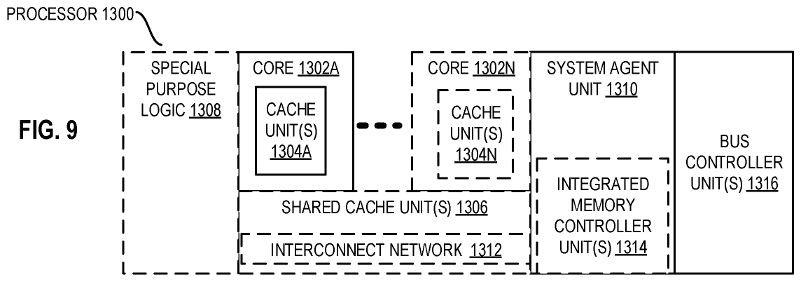

FIG. 9 is a block diagram of a processor 1300 that may have more than one core, may have an integrated memory controller, and may have integrated graphics according to embodiments of the invention. The solid lined boxes in FIG. 9 illustrate a processor 1300 with a single core 1302A, a system agent 1310, a set of one or more bus controller units 1312, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one embodiment a ring based interconnect unit 1312 interconnects the integrated graphics logic 1308 (integrated graphics logic 1308 is an example of and is also referred to herein as special purpose logic), the set of shared cache units 1306, and the system agent unit 1310/integrated memory controller unit(s) 1314, alternative embodiments may use any number of well-known techniques for interconnecting such units. In one embodiment, coherency is maintained between one or more cache units 1306 and cores 1302-A-N.

In some embodiments, one or more of the cores 1302A-N are capable of multi-threading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set.

### Exemplary Computer Architectures

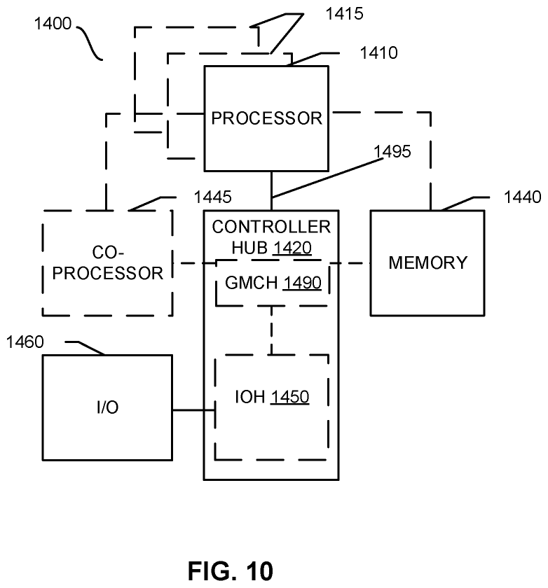

FIGS. 10-13 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 10, shown is a block diagram of a system 1400 in accordance with one embodiment of the present invention. The system 1400 may include one or more processors 1410, 1415, which are coupled to a controller hub 1420. In one embodiment the controller hub 1420 includes a graphics memory controller hub (GMCH) 1490 and an Input/Output Hub (IOH) 1450 (which may be on separate chips); the GMCH 1490 includes memory and graphics controllers to which are coupled memory 1440 and a coprocessor 1445; the IOH 1450 couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450.

The optional nature of additional processors 1415 is denoted in FIG. 10 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface such as QuickPath Interconnect (QPI), or similar connection 1495.

In one embodiment, the coprocessor 1445 is a special-purpose processor, such as, for example, a high-throughput MIC processor, a network or communication processor, compression engine, graphics processor, GPGPU, embedded processor, or the like. In one embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In one embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

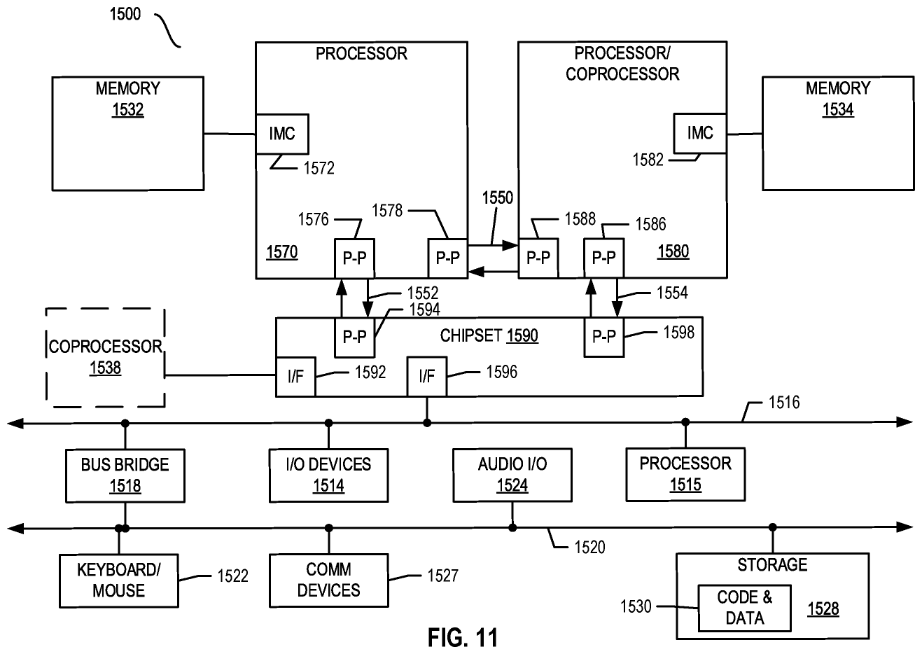

Referring now to FIG. 11, shown is a block diagram of a first more specific exemplary system 1500 in accordance with an embodiment of the present invention. As shown in FIG. 11, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In one embodiment of the invention, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 11, IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1592. In one embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In one embodiment, first bus 1516 may be a Peripheral Component Interconnect (PCI) bus, or a bus such as a PCI Express bus or another third generation I/O interconnect bus, although the scope of the present invention is not so limited.

As shown in FIG. 11, various I/O devices 1514 may be coupled to first bus 1516, along with a bus bridge 1514 which couples first bus 1516 to a second bus 1520. In one embodiment, one or more additional processor(s) 1515, such as coprocessors, high-throughput MIC processors, GPGPU's, accelerators (such as, e.g., graphics accelerators or digital signal processing (DSP) units), field programmable gate arrays, or any other processor, are coupled to first bus 1516. In one embodiment, second bus 1516 may be a low pin count (LPC) bus. Various devices may be coupled to a second bus 1516 including, for example, a keyboard and/or mouse 1518, communication devices 1527 and a storage unit 1528 such as a disk drive or other mass storage device which may include instructions/code and data 1530, in one embodiment. Further, an audio I/O 1524 may be coupled to the second bus 1516. Note that other architectures are possible. For example, instead of the point-to-point architecture of FIG. 11, a system may implement a multi-drop bus or other such architecture.

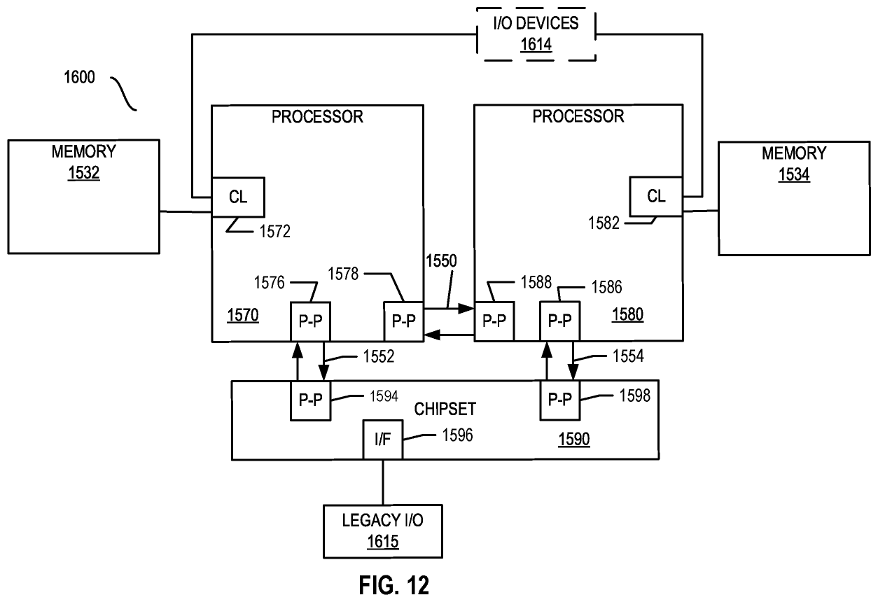

Referring now to FIG. 12, shown is a block diagram of a second more specific exemplary system 1600 in accordance with an embodiment of the present invention. Like elements in FIGS. 11 and 12 bear like reference numerals, and certain aspects of FIG. 11 have been omitted from FIG. 12 in order to avoid obscuring other aspects of FIG. 12.

FIG. 12 illustrates that the processors 1570, 1580 may include integrated memory and I/O control logic (“CL”) 1572 and 1582, respectively. Thus, the CL 1572, 1582 include integrated memory controller units and include I/O control logic. FIG. 12 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

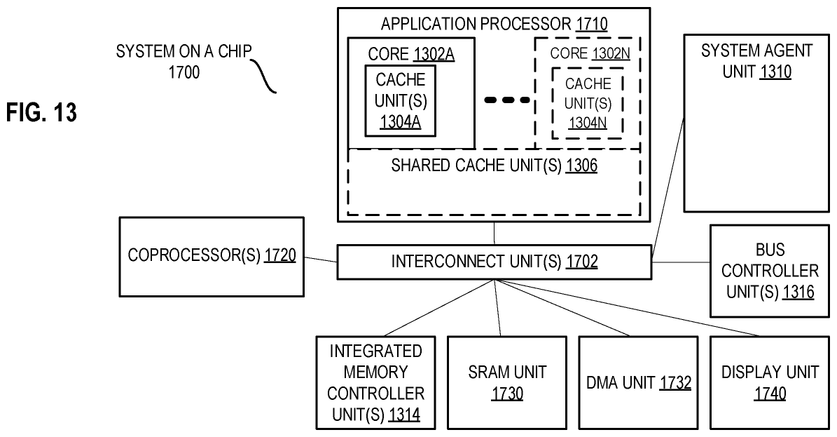

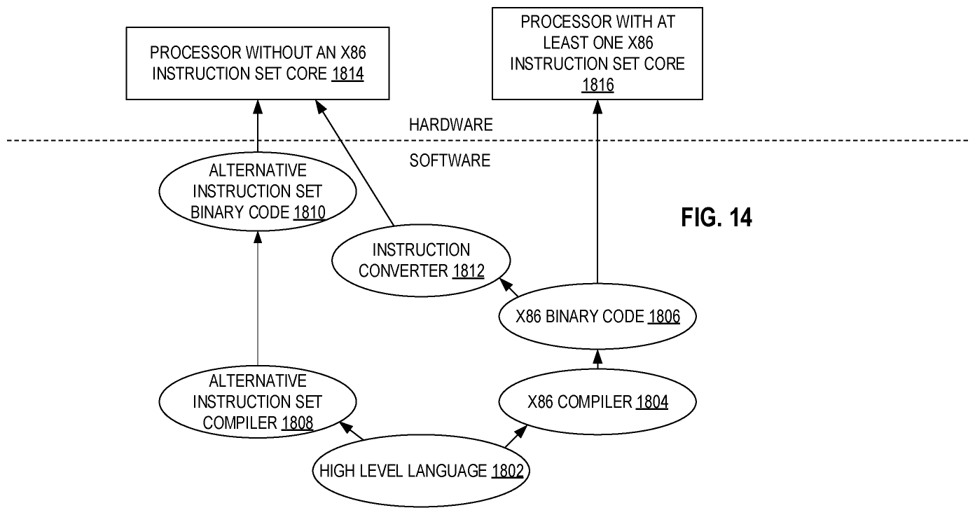

Referring now to FIG. 13, shown is a block diagram of a SoC 1700 in accordance with an embodiment of the present invention. Similar elements in FIG. 9 bear like reference numerals. Also, dashed lined boxes are optional features on more advanced SoCs. In FIG. 13, an interconnect unit(s) 1702 is coupled to: an application processor 1710 which includes a set of one or more cores 1302A-N, which include cache units 1304A-N, and shared cache unit(s) 1306; a system agent unit 1310; a bus controller unit(s) 1316; an integrated memory controller unit(s) 1314; a set or one or more coprocessors 1716 which may include integrated graphics logic, an image processor, an audio processor, and a video processor; an static random access memory (SRAM) unit 1730; a direct memory access (DMA) unit 1732; and a display unit 1740 for coupling to one or more external displays. In one embodiment, the coprocessor(s) 1720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 11, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 10 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 10 shows a program in a high level language 1762 may be compiled using an x86 compiler 1764 to generate x86 binary code 1766 that may be natively executed by a processor with at least one x86 instruction set core 1776. The processor with at least one x86 instruction set core 1776 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1764 represents a compiler that is operable to generate x86 binary code 1766 (e.g., object code) that can, with or without additional linkage processing, be executed on the processor with at least one x86 instruction set core 1776. Similarly, FIG. 10 shows the program in the high level language 1762 may be compiled using an alternative instruction set compiler 1768 to generate alternative instruction set binary code 1770 that may be natively executed by a processor without at least one x86 instruction set core 1774 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1772 is used to convert the x86 binary code 1766 into code that may be natively executed by the processor without an x86 instruction set core 1774. This converted code is not likely to be the same as the alternative instruction set binary code 1770 because an instruction converter capable of this is difficult to make; however, the converted code will accomplish the general operation and be made up of instructions from the alternative instruction set. Thus, the instruction converter 1772 represents software, firmware, hardware, or a combination thereof that, through emulation, simulation or any other process, allows a processor or other electronic device that does not have an x86 instruction set processor or core to execute the x86 binary code 1766.

### FURTHER EXAMPLES

Example 1. A processor comprising: a branch prediction unit to determine a loop exit predictor start corresponding to a finite consistent loop; and an instruction decoder queue to: receive an iteration of the finite consistent loop corresponding to a loop exit predictor and an iteration count; replay one or more instructions of the iteration based on the iteration count; and switch to post-loop instructions responsive to a determination that a number of iterations of the finite consistent loop is equal to the iteration count.

Example 2. The processor of claim 1, wherein the branch prediction unit is to mark a taken branch as loop exit predictable.

Example 3. The processor of claim 1, further comprising a loop exit predictor tracker, the loop exit predictor tracker to equate a number of taken branches as the iteration count.

Example 4. The processor of claim 1, wherein the branch prediction unit is further structured to: determine whether a match of a loop exit predictor entry is confident; and predict the finite consistent loop if the match of the loop exit predictor entry is confident.

Example 5. The processor of claim 1, wherein the received iteration of the finite consistent loop comprises the loop exit predictor start and a loop exit predictor end.

Example 6. The processor of claim 5, wherein the loop exit predictor end is associated with the iteration count for replay of the finite consistent loop.

Example 7. The processor of claim 1, wherein the instruction decoder queue is further structured to: set a read pointer to the loop exit predictor start entry when the read pointer reaches the loop exit predictor end.

Example 8. The processor of claim 7, wherein the branch prediction unit is to redirect fetching to preload the post-loop instructions.

Example 9. A method comprising: determining, via a branch prediction unit, a loop exit predictor start corresponding to a finite consistent loop; receiving, via an instruction decoder queue, an iteration of a loop exit predictor and an iteration count;

replaying, via the instruction decoder queue, one or more instructions of the iteration based on the iteration count; and switching, via the instruction decoder queue, to post-loop instructions responsive to the number of iterations of the loop exit predictor equal to the iteration count.

Example 10. The method of claim 9, wherein the branch prediction unit is to mark a taken branch as loop exit predictable.

Example 11. The method of claim 9, further comprising: determining whether a match of a loop exit predictor entry is confident; and predicting the finite consistent loop if the match of the loop exit predictor entry is confident.

Example 12. The method of claim 9, wherein the received iteration of the finite consistent loop comprises the loop exit predictor start and a loop exit predictor end.

Example 13. The method of claim 9, further comprising setting a read pointer to the loop exit predictor start entry when the read pointer reaches the loop exit predictor end.

Example 14. The method of claim 9, wherein the iteration count may change based on at least one of dynamic execution or global branch history.

Example 15. The method of claim 14, further comprising redirecting fetching to preload the post-loop instructions.

Example 16. A system comprising: a memory; and a processor comprising: a branch prediction unit to determine a loop exit predicator corresponding to a non-finite consistent loop; and an instruction decoder queue to: receive an iteration of a loop exit predictor associated with a large iteration count; replay one or more instructions of the iteration based on the large iteration count; and switch to post-loop instructions responsive to a prediction event.

Example 17. The system of claim 16, wherein the prediction event comprises a jump execution command.

Example 18. The system of claim 16, wherein the branch prediction unit is to:

determine whether a match of a loop exit predictor entry is confident; and start a non-finite consistent loop prediction associated with a reduced warmup if the match of the loop exit predictor is confident.

Example 19. The system of claim 16, wherein the received iteration of the loop exit predictor comprises the loop exit predictor start and a loop exit predictor end.

Example 20. The system of claim 16, wherein the large iteration count comprises an infinite iteration count.

What is claimed is:

1. A processor comprising:
a branch prediction unit to determine a loop exit predictor start corresponding to a finite consistent loop; and
an instruction decoder queue to:
receive an iteration of the finite consistent loop corresponding to a loop exit predictor and an iteration count;
replay one or more instructions of the iteration based on the iteration count; and
switch to post-loop instructions responsive to a determination that a number of iterations of the finite consistent loop is equal to the iteration count.

2. The processor of claim 1, wherein the branch prediction unit is to mark a taken branch as loop exit predictable.

3. The processor of claim 1, further comprising a loop exit predictor tracker, the loop exit predictor tracker to equate a number of taken branches as the iteration count.

4. The processor of claim 1, wherein the branch prediction unit is further structured to:
determine whether a match of a loop exit predictor entry is confident; and
predict the finite consistent loop if the match of the loop exit predictor entry is confident.

5. The processor of claim 1, wherein the received iteration of the finite consistent loop comprises the loop exit predictor start and a loop exit predictor end.

6. The processor of claim 5, wherein the loop exit predictor end is associated with the iteration count for replay of the finite consistent loop.

7. The processor of claim 1, wherein the instruction decoder queue is further structured to:
set a read pointer to the loop exit predictor start entry when the read pointer reaches the loop exit predictor end.

8. The processor of claim 7, wherein the branch prediction unit is to redirect fetching to preload the post-loop instructions.

9. A method comprising:
determining, via a branch prediction unit, a loop exit predictor start corresponding to a finite consistent loop;
receiving, via an instruction decoder queue, an iteration of a loop exit predictor and an iteration count;
replaying, via the instruction decoder queue, one or more instructions of the iteration based on the iteration count; and
switching, via the instruction decoder queue, to post-loop instructions responsive to the number of iterations of the loop exit predictor equal to the iteration count.

10. The method of claim 9, wherein the branch prediction unit is to mark a taken branch as loop exit predictable.

11. The method of claim 9, further comprising:
determining whether a match of a loop exit predictor entry is confident; and
predicting the finite consistent loop if the match of the loop exit predictor entry is confident.

12. The method of claim 9, wherein the received iteration of the finite consistent loop comprises the loop exit predictor start and a loop exit predictor end.

13. The method of claim 9, further comprising setting a read pointer to the loop exit predictor start entry when the read pointer reaches the loop exit predictor end.

14. The method of claim 9, wherein the iteration count may change based on at least one of dynamic execution or global branch history.

15. The method of claim 14, further comprising redirecting fetching to preload the post-loop instructions.

16. A system comprising:
a memory; and
a processor comprising:
a branch prediction unit to determine a loop exit predicator corresponding to a non-finite consistent loop; and
an instruction decoder queue to:
receive an iteration of a loop exit predictor associated with a large iteration count;
replay one or more instructions of the iteration based on the large iteration count; and
switch to post-loop instructions responsive to a prediction event.

17. The system of claim 16, wherein the prediction event comprises a jump execution command.

18. The system of claim 16, wherein the branch prediction unit is to:
determine whether a match of a loop exit predictor entry is confident; and
start a non-finite consistent loop prediction associated with a reduced warmup if the match of the loop exit predictor is confident.

19. The system of claim 16, wherein the received iteration of the loop exit predictor comprises the loop exit predictor start and a loop exit predictor end.

20. The system of claim 16, wherein the large iteration count comprises an infinite iteration count.
